(19) United States
(12) Patent Application Publication
(10) Pub. No.: US 2007/0052779 A1
(43) Pub. Date: Mar. 8, 2007

(54) Ink supplying unit and inkjet image forming apparatus including the same

(75) Inventor: Seo-hyun Cho, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/501,696

(22) Filed: Aug. 10, 2006

(30) Foreign Application Priority Data
Sep. 6, 2005 (KR) 2005-82625

(51) Int. Cl. B41J 2/19

(52) U.S. Cl. 347/92

(57) ABSTRACT

An ink supplying device and an inkjet image forming apparatus including the same. The ink supplying device includes an ink containing unit, a printhead forming an image by ejecting ink onto a printing medium, the ink flowing from the ink containing unit into the printhead through an ink path, and an ultrasonic wave generator which is installed in one side of the ink containing unit and generates ultrasonic waves to remove gas from ink contained in the ink containing unit. Accordingly, since the gas is separated from the ink using ultrasonic waves without heating the ink, the temperature of ink is not increased, and thus, ink properties are not changed. Furthermore, the gas is removed from the ink while the ink passes through an air purging tube, and hence, the gas is prevented from being re-absorbed into the ink. That is, by removing bubbles and gas existing in the ink, an ejecting failure during ejection of ink droplets can be prevented, and thus, printing quality can be improved.

### CROSS-REFERENCE TO RELATED APPLICATIONS

This application claims the priority under 35 U.S.C. §119(a) from Korean Patent Application No. 10-2005-0082625, filed on Sep. 6, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an ink supplying device of an inkjet image forming apparatus, which supplies ink from an ink containing unit while removing gas from the ink.

2. Description of the Related Art

An inkjet image forming apparatus forms an image by ejecting ink from an inkjet head onto a printing medium. Two categories of inkjet image forming apparatus are a shuttle type image forming apparatus and a line-printing type image forming apparatus. The shuttle type image forming apparatus prints an image using a printhead traveling forwards and backwards in a direction perpendicular to a transfer direction of the printing medium. A line-printing type image forming apparatus prints an image with the printhead having a nozzle unit with a length corresponding to a width of a printing medium.

In both the shuttle type and the line-printing type image forming apparatuses, ink stored in an ink containing unit is provided to a printhead by an ink supplying device and is ejected from the printhead onto the printing medium to form the image thereon. In this case, if gas is dissolved in the ink stored in the ink containing unit or air bubbles are produced in the ink which is passing through the ink supplying device, an ink ejection failure may occur, thereby degrading printing quality.

U.S. Pat. No. 4,340,895 discloses a conventional method to degas ink stored in a vessel. In this method, a heating element such as a heater is used to degas the ink contained in the vessel. Specifically, when the ink contained in the vessel is heated by the heater, the ink is degassed according to Henry's law. A heating coil is used to heat the ink, and a temperature of the ink is controlled by a temperature sensor to prevent the ink from overheating. The degassed ink is cooled to a normal temperature by a cooling element. However, since the ink is heated to degas, properties of the ink can be changed. Further, an additional heating element to heat the ink and an additional sensor to prevent ink from overheating are required. Also, an additional cooling element is required to cool the heated ink to the normal temperature.

Meanwhile, air bubbles may be generated in ink which is passing through an ink supplying device. U.S. Pat. No. 4,929,963 discloses a conventional method to solve an ejection failure problem due to air bubbles. An ink supplying device used in the conventional method includes an ink reservoir connected to a head carriage via a duct line, a pump, and a filter/gas separator. When ink is re-circulated, the filter/gas separator separates gas from the ink, gas bubbles pass through a restrictor, and then ink is re-circulated to the ink reservoir. Specifically, gas is separated from the ink by a filter while the ink is being circulated. That is, the gas bubbles are removed from the ink by making the gas bubbles rise. However, the above ink supplying device can remove only large gas bubbles contained in ink, and cannot remove small gas bubbles which circulate with the ink. When the ink containing gas is circulated along a long path, both small and large air bubbles may be generated, which can cause an ejection failure, and printing quality may be degraded. Thus, there exists a need to solve the problem of gas bubbles in ink.

### SUMMARY OF THE INVENTION

The present general inventive concept provides an ink supplying device which effectively removes air bubbles and gas from ink to prevent the ejection failure of a printhead, and an inkjet image forming apparatus including the ink supplying device.

The present general inventive concept also provides an ink supplying device which effectively removes gas from ink without changing properties of the ink, and an inkjet image forming apparatus including the ink supplying device.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an ink supplying device including an ink containing unit, a printhead to form an image by ejecting ink onto a printing medium, the ink flowing from the ink containing unit into the printhead through an ink path, and an ultrasonic wave generator which is installed in one portion of the ink containing unit and generates ultrasonic waves to remove gas from the ink contained in the ink containing unit.

The ultrasonic wave generator may separately direct the gas in an empty space of the ink containing unit.

The ink supplying device may further include a vacuum pump connected to the empty space of the ink containing unit via an ink path and remove the gas from the empty space of the ink containing unit to an outside of the ink containing unit.

The ink supplying device may further include a needle valve disposed on an ink path between the ink containing unit and the vacuum pump to maintain an inside of the ink containing unit at a predetermined negative pressure.

The printhead may include a nozzle unit with a length corresponding to a width of the printing medium.

The ink supplying device may further include at least one air purging tube disposed on the ink path between the ink containing unit and the printhead to discharge gas in the ink from an inner wall of the air purging tube to the outside.

The at least one air purging tube may include an air purging membrane.

The ultrasonic wave generator may be installed on an inner bottom surface of the ink containing unit.

The foregoing and/or other aspects of the present general inventive concept may also be achieved by providing an inkjet image forming apparatus including an ink supplying device including an ink containing unit, a printhead to form an image by ejecting ink onto a printing medium, the ink flowing from the ink containing unit into the printhead through an ink path; and an ultrasonic wave generator which is installed in one portion of the ink containing unit and generates ultrasonic waves to remove gas from ink contained in the ink containing unit.

The ultrasonic wave generator may direct the gas in an empty space of the ink containing unit.

The ink supplying device may further include a vacuum pump connected to the empty space of the ink containing unit via an ink path and may remove the gas from the empty space of the ink containing unit to an outside of the ink containing unit.

The inkjet image forming apparatus may further include a needle valve disposed on the ink path between the ink containing unit and the vacuum pump to maintain an inside of the ink containing unit at a predetermined negative pressure.

The printhead may include a nozzle unit with a length corresponding to a width of the printing medium.

The inkjet image forming apparatus may further include at least one air purging tube disposed on the ink path between the ink containing unit and the printhead to discharge gas in the ink from an inner wall of the air purging tube to the outside.

The at least one air purging tube may include an air purging membrane.

The ultrasonic wave generator may be installed on an inner bottom surface of the ink containing unit.

The foregoing and/or other aspects of the present general inventive concept may also be achieved by providing an ink supplying device usable in an image forming apparatus including a printhead unit an ink containing unit to contain ink from the printhead unit, and an air removing unit installed in the ink containing unit to remove air from the ink.

The foregoing and/or other aspects of the present general inventive concept may also be achieved by providing an inkjet image forming apparatus including an ink supplying device including a printhead unit an ink containing unit to contain ink from the printhead unit, and an air removing unit installed in the ink containing unit to remove air from the ink.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating an image forming apparatus according to an embodiment of the present general inventive concept;

FIG. 2 is a plan view illustrating a printhead of the inkjet image forming apparatus of FIG. 1; and

FIG. 3 is an exploded perspective view illustrating a structure of the printhead of FIG. 2;

FIG. 4 is a cross-sectional view illustrating a process of an ink droplet from the printhead illustrated FIG. 3;

FIG. 5 is a cross-sectional view illustrating an ink supplying device according to an embodiment of the present general inventive concept; and

FIG. 6 is a block diagram illustrating an ink supplying device according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain to the present general inventive concept by referring to the figures. In the drawings, the thicknesses of lines and sizes are exaggerated for clarity and convenience.

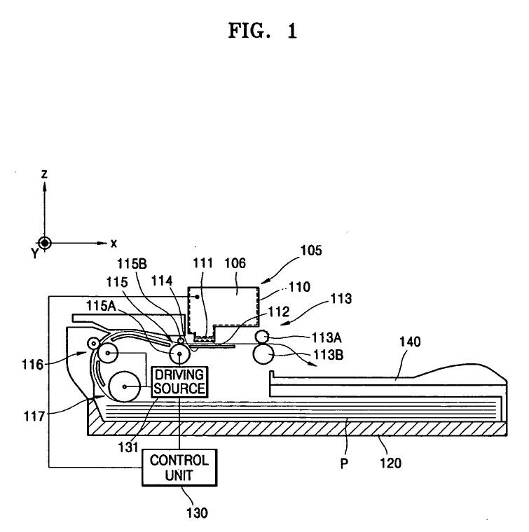

FIG. 1 is a cross-sectional view illustrating an image forming apparatus according to an embodiment of the present general inventive concept. Referring to FIG. 1, the inkjet image forming apparatus includes a paper feeding cassette 120, a printhead unit 105, a supporting member 114 opposite the printhead unit 105, a printing medium conveying unit (e.g., rollers 113, 115, 116, and 117) that conveys a printing medium P in a first direction (direction X), and a stacking unit 140 in which the printing medium P is discharged and then stacked. In addition, the image forming apparatus includes a control unit 130.

The printing medium P is stacked in the paper feeding cassette 120. The printing medium P stacked in the feeding cassette 120 is conveyed passing through a printhead 111 of the printhead unit 105 to the stacking unit 140 by the printing medium conveying unit. The printing medium P is discharged and then stacked on the stacking unit 140 such as a discharge tray.

The printing medium conveying unit conveys the printing medium P stacked in the feeding cassette 120 along a predetermined path, and may inlcude a pickup roller 117, auxiliary rollers 116, feeding rollers 115, and discharge rollers 113. The printing medium conveying unit is driven by a driving source 131 such as a motor, which provides a driving force to covey the printing medium P. The operation of the driving source 131 is controlled by the control unit 130, which will be described later.

The pickup roller 117 may be installed in one side of the feeding cassette 120, and picks up the printing medium P stacked in the feeding cassette 120. The feeding rollers 115 are installed in a portion of the printhead 111 where the printing medium is fed into, and conveys the printing medium P from the feeding cassette 120 with the use of the pickup roller 117 which conveys the printing medium P to the printhead 111. The feeding rollers 115 includes a driving roller 115A that provides a transferring force to convey the printing medium P, and an idle roller 115B that is elastically engaged with the driving roller 115A. The auxiliary rollers 116 may be further installed in pair between the pickup roller 117 and the feeding rollers 115 to convey the printing medium P. The discharge rollers 113 are installed in a portion of the image forming apparatus where the printing medium P is discharged, and the discharge rollers 113 discharge the printing medium P on which an image has been printed to an outside of the image forming apparatus. The discharge rollers 113 include a star wheel 113A installed parallel to a widthwise direction of the printing medium P and a supporting roller 113B that is opposite the star wheel 113A and supports a back surface of the printing medium P The printing medium P discharged from the image forming apparatus is stacked in the stacking unit 140.

The supporting member 114 is installed under the printhead 111 of the printhead unit 105 and supports a back surface of the conveyed printing medium P to maintain a predetermined distance between a nozzle unit 112 of the printhead 111 and the printing medium P. The predetermined distance between the nozzle unit 112 and the printing medium P can be about 0.5-2.5 mm.

The control unit 130 is installed on a motherboard (not shown), and controls a firing operation of the nozzle unit 112 formed on the printhead 111, and a transferring operation of the printing medium conveying unit. That is, the control unit 130 synchronizes operations of various elements in the image forming apparatus so that ink ejected from the nozzle unit 112 is placed at a desired position on the printing medium P.

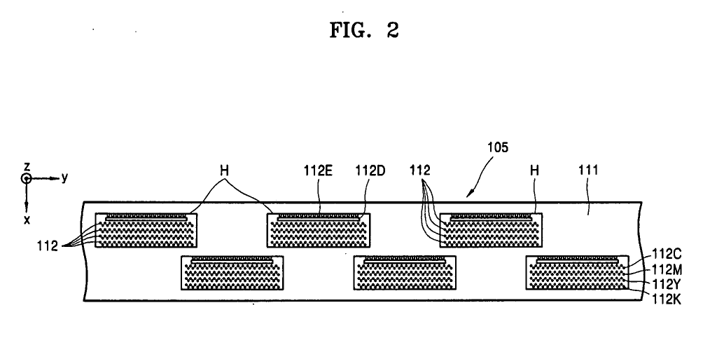

The printhead unit 105 forms an image by ejecting ink onto the printing medium P, and includes a body 110 and a frame 106 mounted on the body 110. The printhead 111 including the nozzle unit 112 having a plurality of nozzles (see FIG. 2) is installed on a bottom surface of the frame 106. The printhead 111 may be of a shuttle type or a line-printing type. The shuttle type printhead forms an image on the printing medium P while moving forwards and backwards in a widthwise direction of the printing medium P, and the line-printing type printhead includes a nozzle unit with a length corresponding to a width of the printing medium P. The feeding rollers 115 are installed in an inlet portion of the nozzle unit 112 where the printing medium P is fed into, and the discharge rollers 113 are rotatably installed in an outlet portion of the nozzle unit 112 where the printing medium P is fed out. Hereinafter, for convenience of explanation, a line-printing type printhead unit which has a length corresponding to a width of a printing medium will be described as an example.

FIG. 2 is a plan view illustrating the printhead 111 of the inkjet image forming apparatus of FIG. 1. Referring to FIGS. 1 and 2, the printhead 111 is installed in a direction Y with respect to the printing medium P which is conveyed in the direction X. The printhead 111 uses heat energy or a piezoelectric element as an ink firing source, and is fabricated to have a high resolution through a semiconductor manufacturing process such as etching, depositing, and sputtering. The nozzle unit 112 is formed on the printhead 111 to form an image by ejecting ink onto the printing medium P. The nozzle unit 112 has a length corresponding to a width of the printing medium P, or may be formed longer than the width of the printing medium P.

According to the present embodiment, a plurality of head chips H, each formed with a plurality of nozzle arrays 112C, 112M, 112Y, and 112K are mounted on the printhead 111. A driving circuit 112D is included in each of the plurality of head chips H to selectively drive respective nozzles or groups of nozzles. When the plurality of head chips H are longitudinally arranged, a distance between nozzles of adjacent head chips H may be wider than a distance between nozzles within a same head chip H, and thus a region onto which ink is not ejected on the printing medium P may be generated. Therefore, the plurality of head chips H may be desirably arranged in a zigzag pattern. Furthermore, nozzle arrays ejecting a same color ink among the nozzle arrays 112C, 112M, 112Y, and 112K on each of the plurality of head chips H may also be desirably arranged in a zigzag pattern to improve resolution in a direction Y. As a result, ink dots ejected from nozzles of one of the nozzle arrays 112C, 112M, 112Y, and 112K are fired between ink dots ejected from nozzles of other nozzle arrays, and the resolution in the direction Y is therefore improved. Although the printhead 111 including the nozzle unit 112 having the plurality of head chips H arranged in a zigzag pattern is described as an example of the present embodiment, the nozzle unit 112 can be implemented in a variety of shapes and/or patterns. For instance, the nozzle unit 112 may be fabricated as a single head chip H with a length corresponding to a width of the printing medium P, or may include a nozzle array arranged to correspond to a length of the printing medium P. That is, the illustrated nozzle unit 112 of the printhead 111 is only one embodiment of the present general inventive concept, and the scope of the present general inventive concept is not limited to the structure of the illustrated nozzle unit 112.

Each of nozzles formed on the nozzle unit 112 is connected to the driving circuit 112D and a cable 112E through which a driving signal, power to eject ink, and image data are transmitted by the control unit 130. The cable 112E may be a flexible cable such as a flexible printed circuit (FPC) or a flexible flat cable (FFC).

The printhead 111 with the above structure forms an image by ejection of ink supplied by an ink supplying device which will be described later, with use of the nozzles to eject the ink onto the printing medium P. For example, the structure of the printhead and an operation of ejecting ink droplets will be briefly described. In general, a printhead may be categorized into two types according to an ink droplet ejection mechanism. One is a thermal type printhead that ejects ink droplets due to an expansion force of bubbles generated in ink by a heating source, and the other one is a piezoelectric type printhead that includes a piezoelectric element and ejects ink droplets by pressure applied to ink due to a change of the piezoelectric element. By way of explanation, the thermal type printhead will be described as an example.

The ink droplet ejecting mechanism of the thermal type printhead will be described in detail below. When a pulse current flows through a heater formed of a heating element, the heater instantaneously applies heat to the ink to boil the ink and generate bubbles therein, and the generated bubbles expand and apply pressure to the ink contained in a chamber. Consequently, ink around the nozzle spits or ejects from the nozzle in a droplet form.

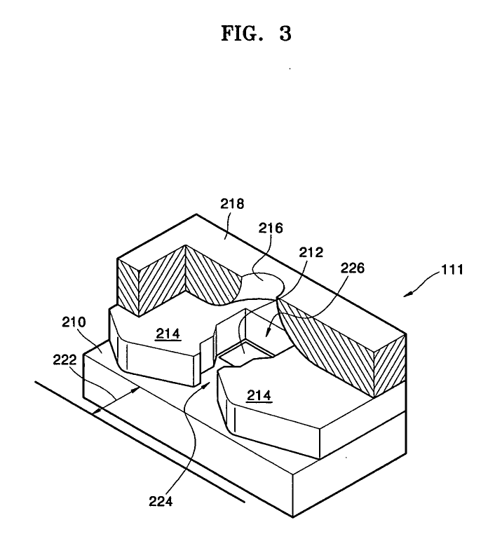

FIG. 3 is an exploded perspective view illustrating a structure of the printhead 111 of FIG. 2, and FIG. 4 is a cross-sectional view illustrating a process of ejecting an ink droplet from the printhead 111 illustrated FIG. 3.

Referring to FIGS. 3 and 4, the printhead 111 includes a substrate 210, barrier ribs 214 mounted on the substrate 210 to define an ink chamber 226 which is filled with ink 229, a heater 212 that is a driving unit installed in the ink chamber 226, and a nozzle plate 218 formed on the barrier ribs 214 and formed with a nozzle 216 to eject an ink droplet 229′. When a pulse current is applied to the heater 212 to generate heat, ink 229 filling the ink chamber 226 is heated to generate bubbles. The generated bubbles continuously expand, and accordingly, pressure is applied to the ink 229 filling the ink chamber 226 to eject the ink droplet 229′ through the nozzle 216. Then, the ink 229 is provided from an ink containing unit to an inside of the ink chamber 226 by the an supplying device through a manifold 222 and an ink channel 224. Surface tension of the nozzle 226 and negative pressure thereof are balanced with each other so that the ink 229 remains inside the ink chamber 226. At this moment, if air bubbles are included in the ink flowing into the ink chamber 226, the air bubbles can cause a generation of bubbles 228 by the heater 212. Moreover, the air bubbles in the ink can cause an ejection failure, thereby deteriorating printing quality. Therefore, when the ink is supplied to the ink chamber 226, the air bubbles are desirably removed from the ink.

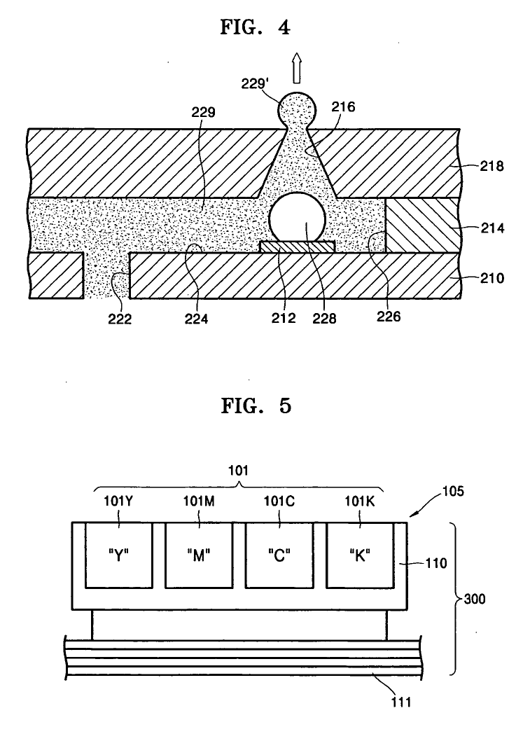

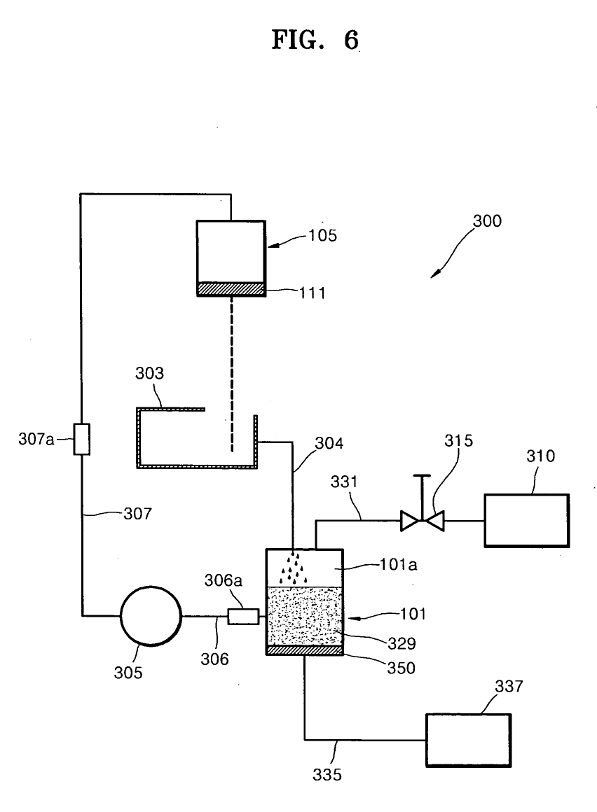

FIG. 5 is a cross-sectional view illustrating an ink supplying device 300 according to an embodiment of the present general inventive concept, and FIG. 6 is a block diagram illustrating the ink supplying device 300 according to another embodiment of the present general inventive concept.

An ink containing unit and a printhead may be integrated with each other, or separately formed. That is, as illustrated in FIG. 5, ink containing units 101, a printhead 111, and the ink supplying device 300 that provides ink from the ink containing unit 101 to the printhead 111 may be integrated with each other, or, as illustrated in FIG. 6, separately formed.

According to the present embodiment, as illustrated in FIG. 5, the ink supplying device 300 that provides ink from ink containing units 101Y, 101M, 101C, and 101K to the printhead 111 may be integrated with the ink containing units 101Y, 101M, 101C, and 101K and the printhead 111. The ink containing units 101Y, 101M, 101C, and 101K respectively store yellow ink, magenta ink, cyan ink, and black ink. The ink containing units 101Y, 101M, 101C, and 101K may be detachably installed in a body 110. The ink may be supplied from the ink containing units 101, which are formed on a printhead unit 105, to the printhead 111 by the ink supplying unit 300 as illustrated in FIG. 5. Alternatively, the ink may be supplied from the ink containing unit 101, which may be formed separately from the printhead unit 105, to the printhead 111 by the ink supplying device 300. Hereinafter, the structure and operation of the ink supplying device 300 will be described in detail with reference to FIG. 6.

Referring to FIG. 6, the ink supplying device 300 supplies ink to the printhead 111, and includes the ink containing unit 101, the printhead 111, an ink circulation pump 305, a gutter 303, a vacuum pump 310, an ultrasonic wave generator 350, and ink paths 304, 306, 307, and 331 through which the ink is supplied to each element.

The ink containing unit 101 stores ink which is ejected from a nozzle of the printhead 111 onto a printing medium. The ink stored in the ink containing unit 101 flows into the ink paths 306 and 307, and then, is supplied to the printhead unit 105 by the ink circulation pump 305, which will be described later.

The ultrasonic wave generator 350 is installed in one portion of the ink containing unit 101, and removes gas from the ink contained in the ink containing unit 101. The ultrasonic wave generator 350 may be installed on a side portion or a bottom portion of the ink containing unit 101. The ultrasonic wave generator 350 generates ultrasonicwaves in the ink stored in the ink containing unit 101. When the ultrasonic waves are generated, bubbles are produced in the ink in a traveling path of the ultrasonic waves. That is, gas existing in the ink is separated from the ink through a process called cavitation, which is a phenomenon where small and large empty cavities (e.g., made of gas, such as air) are generated in the ink by the ultrasonic wave. The gas separated from the ink moves to an empty space 101a located in an upper portion of the ink containing unit 101 opposite to a direction of gravity. Hence, to effectively remove existing gas from the ink, the ultrasonic wave generator 350 may be installed on an inner bottom surface of the ink containing unit 101. The ultrasonic wave generator 350 is driven by receiving a force from a driving source 337 via an electrical wire 335. A detailed description of the ultrasonic wave generator 350 is well known and thus the detailed description thereof will not be presented herein.

The vacuum pump 310 is connected to the empty space 101a of the ink containing unit 101 via the ink path 331, and removes the separated gas accumulated in the empty space 101a of the ink containing unit 101 to an outside of the ink containing unit 101. Additionally, the vacuum pump 310 maintains an inside of the ink containing unit 101 at a predetermined pressure when a pressure inside the ink containing unit 101 is increased due to the gas removed by the ultrasonic wave generator 350.

A needle valve 315 is installed between the ink containing unit 101 and the vacuum pump 310, and maintains an inside of the ink containing unit 101 at a predetermined negative pressure.

The ink circulation pump 305 provides the ink 329, from which the gas has been removed, to the printhead 111 through the ink paths 306 and 307. The ink 329 supplied to the printhead 111 is then used to print. In this case, ink which is not used to print, for example, ink ejected during a maintenance operation, such as spitting, is accumulated in the gutter 303 formed in a bottom portion of the printhead 111. The ink accumulated in the gutter 303 is moved to the ink containing unit 101 through the ink path 303 to be reused.

The ink paths 306 and 307 through which ink moves and which are disposed between the ink containing unit 101 and the printhead unit 105 may include respective air purging tubes 306a and 307a. Each of the air purging tubes 306a and 307a has a predetermined length, and discharges gas included in ink passing through the ink paths 306 and 307 from an inner wall of each of the air purging tubes to an outside thereof.

That is, the air purging tubes 306a and 307a only discharge gas from the ink to the outside. At this moment, the gas in the ink is discharged from an inner wall of the air purging tubes to the outside due to a pressure difference between the inside the air purging tubes and the outside. The air purging tubes may include an air purging membrane. The air purging membrane may be Teflon such as Gore-Tex, knitted fiber such as nylon, polyester, or a polyphenylene (PPS) based foam film.

Referring back to FIG. 5, the ink supplying device 300 may include at least one element, for example, the ultrasonic wave generator 350 or the air purging tube 306a or 307a, illustrated in FIG. 6 between the printhead 111 and the ink containing unit 101 to supply the ink collected from the printhead 111 to the ink containing unit 101 by removing bubbles from an ink path to the body 110.

According to the structure described above, the present general inventive concept includes an ultrasonic wave generator and at least one air purging tube, thereby effectively removing gas from ink. Both large gas bubbles and small gas bubbles that circulate with the ink may be removed. Thus, ink ejection failure can be reduced and printing quality can be improved.

As described above, according to the present general inventive concept, since an ink supplying device and an inkjet image forming apparatus including the ink supplying device separate gas from ink using ultrasonic waves without heating the ink, the temperature of the ink is not increased, and thus ink properties are not changed. Furthermore, the inkjet image forming apparatus according to the present general inventive concept does not require a heating unit, a temperature sensor to prevent overheating of ink, and a cooling unit that cools the heated ink to a normal temperature, and thus, manufacturing costs and after-sales service costs can be reduced, and customer reliability can be increased. In addition, since ultrasonic waves are used to remove the gas from the ink, the gas can be more effectively and thoroughly removed from the ink. The gas may be removed from the ink while the ink is passing through air purging tubes, and hence, the gas is prevented from being re-absorbed into the ink. That is, by removing bubbles and gas existing in the ink, an ejection failure during ejection of ink droplets can be prevented, and thus printing quality can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink supplying device comprising:
an ink containing unit;
a printhead to form an image by ejecting ink onto a printing medium, the ink flowing from the ink containing unit into the printhead through an ink path; and
an ultrasonic wave generator which is installed in one portion of the ink containing unit, and generates ultrasonic waves to remove gas from the ink contained in the ink containing unit.

2. The ink supplying device of claim 1, wherein the ultrasonic wave generator separates the gas from the ink and directs the separated ink to an empty space of the ink containing unit.

3. The ink supplying device of claim 2, further comprising:
a vacuum pump connected to the empty space of the ink containing unit via the ink path to remove the gas from the empty space of the ink containing unit to an outside of the ink containing unit.

4. The ink supplying device of claim 3, further comprising:
a needle valve disposed on the ink path between the ink containing unit and the vacuum pump to maintain an inside of the ink containing unit at a predetermined negative pressure.

5. The ink supplying device of claim 1, wherein the printhead comprises a nozzle unit with a length corresponding to a width of the printing medium.

6. The ink supplying device of claim 1, further comprising:
at least one air purging tube disposed on the ink path between the ink containing unit and the printhead to discharge the gas in the ink from an inner wall of the air purging tube to an outside.

7. The ink supplying device of claim 6, wherein the at least one air purging tube comprises an air purging membrane.

8. The ink supplying device of claim 1, wherein the ultrasonic wave generator is installed on an inner bottom surface of the ink containing unit.

9. An inkjet image forming apparatus comprising:
an ink supplying device comprising:
an ink containing unit;
a printhead to form an image by ejecting ink onto a printing medium, the ink flowing from the ink containing unit into the printhead through an ink path; and
an ultrasonic wave generator which is installed in one portion of the ink containing unit, and generates ultrasonic waves to remove gas from ink contained in the ink containing unit.

10. The inkjet image forming apparatus of claim 9, wherein the ultrasonic wave generator separates the gas from the ink and directs the separated gas to an empty space of the ink containing unit.

11. The inkjet image forming apparatus of claim 10, wherein the ink supplying device further comprises a vacuum pump connected to the empty space of the ink containing unit via an ink path to remove the gas from the empty space of the ink containing unit to an outside of the ink containing unit.

12. The inkjet image forming apparatus of claim 11, wherein the ink supplying device further comprises a needle valve disposed on the ink path between the ink containing unit and the vacuum pump to maintain an inside of the ink containing unit at a predetermined negative pressure.

13. The inkjet image forming apparatus of claim 9, wherein the printhead comprises a nozzle unit with a length corresponding to a width of the printing medium.

14. The inkjet image forming apparatus of claim 9, wherein the ink supplying device further comprises at least one air purging tube disposed on the ink path between the ink containing unit and the printhead to discharge the gas in the ink from an inner wall of the air purging tube to an outside.

15. The inkjet image forming apparatus of claim 14, wherein the at least one air purging tube comprises an air purging membrane.

16. The inkjet image forming apparatus of claim 9, wherein the ultrasonic wave generator is installed on an inner bottom surface of the ink containing unit.

17. An ink supplying device usable in an image forming apparatus, comprising:
a printhead unit;
an ink containing unit to contain ink from the printhead unit; and
an air removing unit installed in the ink containing unit to remove air from the ink.

18. The ink supplying device of claim 17, further comprising:
a pipe unit disposed between the ink containing unit and the printhead unit; and
an air purging tube disposed in the pipe unit to discharge the air from the ink to an outside of the pipe unit.

19. The ink supplying device of claim 18, wherein the air containing unit, the printhead unit, the pipe unit, and the air removing unit are formed in a monolithic single body.

20. The ink supplying device of claim 17, wherein the air removing unit comprises an ultrasonic wave generator disposed in the ink containing unit to generate an ultrasonic wave to the ink to separate the air from the ink.

21. The ink supplying device of claim 18, wherein the air purging tube is an air purging membrane and is formed of Teflon, nylon, polyester, or a polyphenylene (PPS) foam film.

22. An image forming apparatus comprising:
an ink supplying device comprising: a printhead unit;
an ink containing unit to contain ink from the printhead unit; and
an air removing unit installed in the ink containing unit to remove air from the ink.
